(19) United States
(12) Patent Application Publication
(10) Pub. No.: US 2002/0168998 A1
(43) Pub. Date: Nov. 14, 2002

(54) Cellular telephone interface device and method

(76) Inventor: Robert J. van Winkel, Jacksonville, FL (US)

Correspondence Address: Arthur G. Yeager, P. A., Suite 1305, 112 West Adams street, Jacksonville, FL, 32202-3853, US

(21) Appl. No.: 09/852,584

(22) Filed: May 10, 2001

(51) Int. Cl. H04M 1/00

(52) U.S. Cl. 455/552; 455/426; 455/462; 455/465

(57) ABSTRACT

A device allows users to convert and integrate a wireless (cellular) phone to wire (home phone) using existing home wiring infrastructure and telephone device. The device generates dial tone and ringer voltage, allowing both incoming and outgoing calls, and may allow elimination of an incoming wireline. A cell phone battery charger is included.

### CROSS-REFERENCE TO RELATED APPLICATION

Not Applicable.

### STATEMENT REGARDING FEDERALLY SPONSORED RESEARCH OR DEVELOPMENT

Not Applicable.

### REFERENCE TO A MICROFICHE APPENDIX

Not Applicable.

### BACKGROUND OF THE INVENTION

1. Field of the Invention

The present invention relates to conversion and interfacing devices for interconnecting a singular cell phone to a plurality of analog household telephones.

2. Description of Related Art

There is a wide variety of systems and device for facilitating the use of both cellular and wired telephones in a single network. None of apparatus of the prior art provides a simple, inexpensive device for allowing a home telephone system to be disconnected from a wired system and allowing each analog phone in the home to call out or receive incoming calls using a single cell phone.

### BRIEF SUMMARY OF THE INVENTION

In one aspect of the present invention there is provided a cellular telephone interface device for providing reception of an incoming call by cellular telephone and relay of such call to at least one standard telephone set comprising a cellular telephone, at least one standard telephone set, ring generator means operatively connected between the cellular telephone and at least one telephone set for providing a ring output signal to at least one telephone set, power supply means for providing electric power to the ring generator means and output circuit means operatively connected to the cellular telephone for relaying a call received by the cellular telephone to at least one standard telephone set after answer of at least one telephone set. The device also includes battery-charging means for charging a battery in the cellular phone. The ring generator means includes voltage control means for providing 48 VDC to at least one standard telephone set and 96 VAC to the output circuit means for ringing at least one standard telephone set. The output circuit means also includes a J11 telephone jack. The power supply means includes a 110/220 VAC auto sensor transformer means down to 12 VDC. The ring generator means includes means for generating a dial tone when at least one standard telephone set is placed off-hook.

In other aspects of the present invention there is provided a cellular telephone interface system for providing reception and transmission of calls by a cellular telephone and the relay of incoming and outgoing calls to and from a plurality of standard interconnected telephone sets comprising a cellular telephone, a plurality of standard telephone sets, ring generator means operatively connected to the cellular telephone for providing a ring signal and a dial tone signal to each standard telephone set, power supply means for providing electric power to the ring generator means and circuit means operatively connected between the cellular telephone and each standard telephone set for directing a call between the cellular telephone and each standard telephone set. The device includes battery-charging means for charging a battery in the cellular phone. The ring generator means includes voltage control means for providing 48 VDC to each standard telephone set. The circuit means includes a J11 telephone jack. The power supply means includes a 110/220 VAC auto sensor transformer means down to 12 VDC. The ring generator means includes means for generating a dial tone when any standard telephone set is placed off-hook. Also included is a DTMF keystroke-detecting means for receiving calls from each standard telephone set and transmitting such calls from the cellular telephone.

Other aspects of the invention include a method of receiving and transmitting telephone calls by a cellular telephone and the relay of such calls to and from a plurality of standard telephone sets comprising the steps of interconnecting standard telephone sets; connecting a cellular telephone to the telephone sets interconnected; ringing the telephone sets when a call is received by the cellular telephone and relaying the call received from the cellular telephone when a telephone set is placed off-hook to such telephone set. Additional steps include receiving by such cellular telephone a call from a telephone set; relaying such telephone call from the telephone set to a cellular telephone; transmitting the call from such cellular telephone; receiving by such cellular telephone a DTMF keystroke signal from such telephone set; providing a dial tone to a telephone set when such set is placed off-hook; and recharging the battery in the cellular telephone.

### BRIEF DESCRIPTION OF THE SEVERAL VIEWS OF THE DRAWING

The novel features which are believed to be characteristic of this invention are set forth with particularity in the appended claims. The invention itself, however, both as to its organization and method of operation, together with further objects and advantages thereof, may best be understood by reference to the following description, taken in connection with the accompanying drawings, in which:

FIG. 1 is a top plan diagram of a home employing several analog telephones connected to a wired telephone system;

FIG. 2 illustrates the power source used in the interface device in accord with the present invention; and

FIG. 3 is a perspective view of the interface device in accord with the present invention as it would appear in use.

### DETAILED DESCRIPTION OF THE INVENTION

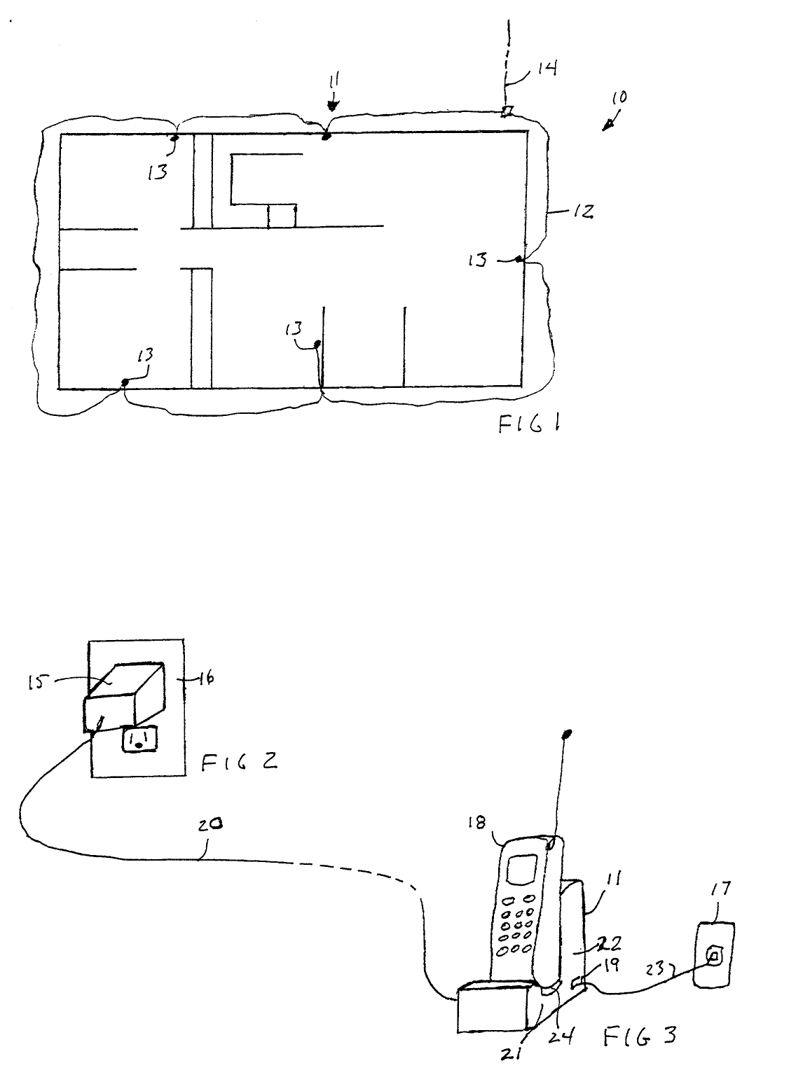

A home telephone system employing the interface device in accord with the present invention is illustrated at numeral 10 in FIG. 1. Interface device 11 is connected via the home telephone wiring 12 to a plurality of phones 13. The connection between wiring 12 and the outside telephone system wiring 14 is shown disconnected, but may remain connected if desired.

FIG. 2 illustrates a transformer 15 in wall receptacle 16 that supplies 12 VDC power to the device 11 in FIG. 3 via power line 20. Transformer 15 is preferably a 110/220 VAC auto sensor to 12 VDC device.

In FIG. 3, cell phone 18 is held in the interface device 11, which is constructed as a docking port or cradle including a cell phone battery charger 21 and a tone/ring generator section 22. Device 11 functions as a telephone call interface and supplies 48 VDC to output circuitry including line jack 19 which is a standard RJ11 jack. When an incoming call is received by phone 18, the device 11 supplies 96 VAC via voltage control circuitry, which is in ring generator 22, to jack 19 as ring voltage to the connected phones 13 via standard wall phone receptacle 17 by line 23.

When a phone 13 is picked up (off-hook) a dial tone is provided to it from voltage control circuitry in ring generator 22 via receptacle 17.

Device 11 includes a standard DTMF detecting circuit to allow a phone 13 to call out via cell phone 18 when a valid sequence is detected. Incoming calls via phone 18 will ring all phones 13 allowing a user to receive an incoming call at any phone 13 by relaying the call from cell phone 18 through jack 19.

All components in the present invention are standard in the art. As also understood in the art, jack 19 will support at least three phones directly. The preferred embodiment of the present invention, the device 11, connects to standard 2500 analog telephone sets. Cell phone input/output receptacle 24 is designed to accommodate a wide variety of cell phones 18.

While the invention has been described with respect to certain specific embodiments, it will be appreciated that many modifications and changes may be made by those skilled in the art without departing from the spirit of the invention. It is intended, therefore, by the appended claims to cover all such modifications and changes as fall within the true spirit and scope of the invention.

What is claimed as new and what it is desired to secure by Letters Patent of the United States is:

1. A cellular telephone interface device for providing reception of an incoming call by a cellular telephone and relay of such call to at least one standard telephone set comprising a cellular telephone, at least one standard telephone set, ring generator means operatively connected between said cellular telephone and said at least one telephone set for providing a ring output signal to said at least one telephone set, power supply means for providing electric power to said ring generator means, output circuit means operatively connected to said cellular telephone for relaying a call received by said cellular telephone to said at least one standard telephone set after answer of said at least one telephone set.

2. The device as defined in claim 1 further including battery-charging means for charging a battery in said cellular phone.

3. The device as defined in claim 1 wherein said ring generator means includes voltage control means for providing 48 VDC to said at least one standard telephone set.

4. The device as defined in claim 1 wherein said voltage control means supplies 96 VAC to said output circuit means for ringing said at least one standard telephone set.

5. The device as defined in claim 1 wherein said output circuit means includes a J11 telephone jack.

6. The device as defined in claim 1 wherein said power supply means includes a 110/220 VAC auto sensor transformer means down to 12 VDC.

7. The device as defined in claim 1 wherein said ring generator means includes means for generating a dial tone when said at least one standard telephone set is placed off-hook.

8. A cellular telephone interface system for providing reception and transmission of calls by a cellular telephone and the relay of incoming and outgoing calls to and from a plurality of standard interconnected telephone sets comprising a cellular telephone, a plurality of standard telephone sets, ring generator means operatively connected to said cellular telephone for providing a ring signal and a dial tone signal to each said standard telephone set, power supply means for providing electric power to said ring generator means, circuit means operatively connected between said cellular telephone and each said standard telephone set for directing a call between said cellular telephone and each said standard telephone set.

9. The device as defined in claim 8 further including battery-charging means for charging a battery in said cellular phone.

10. The device as defined in claim 8 wherein said ring generator means includes voltage control means for providing 48 VDC to each said standard telephone set.

11. The device as defined in claim 10 wherein said voltage control means supplies 96 VAC to said output circuit means for ringing each said standard telephone set.

12. The device as defined in claim 8 wherein said circuit means includes a J11 telephone jack.

13. The device as defined in claim 8 wherein said power supply means includes a 110/220 VAC auto sensor transformer means down to 12 VDC.

14. The device as defined in claim 8 wherein said ring generator means includes means for generating a dial tone when any of said standard telephone set is placed off-hook.

15. The device as defined in claim 8 further including DTMF keystroke-detecting means for receiving calls from each said standard telephone set and transmitting such calls from said cellular telephone.

16. A method of receiving and transmitting telephone calls by a cellular telephone and the relay of such calls to and from a plurality of standard telephone sets comprising the steps of:
A. interconnecting standard telephone sets;
B. connecting a cellular telephone to the telephone sets interconnected in step A;
C. ringing the telephone sets of step A when a call is received by the cellular telephone of step B; and
D. relaying the call received in step C from the cellular telephone of step B when a telephone set is placed off-hook to such telephone set.

17. The method of claim 16 further including the steps of:
E. receiving by such cellular telephone a call from a telephone set;
F. relaying such telephone call from the telephone set of step E to a cellular telephone; and
G. transmitting the call of step F from such cellular telephone.

18. The method of claim 17 wherein step E includes the step of:
H. receiving by such cellular telephone a DTMF keystroke signal from such telephone set.

19. The method of claim 17 wherein step E includes the step of:
H. providing a dial tone to a telephone set when such set is placed off-hook.

20. The method of claim 16 further including the step of:
E. recharging the battery in the cellular telephone of step B.
